(19) United States
(12) Patent Application Publication
(10) Pub. No.: US 2026/0004041 A1
(43) Pub. Date: Jan. 1, 2026

(54) DEADLOCK-FREE MODIFICATION TO NETWORK-ON-CHIP TOPOLOGY

(71) Applicant: ARTERIS, INC., Campbell, CA (US)

(72) Inventor: Amir CHARIF, Paris (FR)

(73) Assignee: ARTERIS, INC., Campbell, CA (US)

(21) Appl. No.: 19/256,057

(22) Filed: Jun. 30, 2025

Related U.S. Application Data
(60) Provisional application No. 63/666,247, filed on Jul. 1, 2024.

(51) Int. Cl. G06F 30/394; G06F 30/31; G06F 115/02

(52) U.S. Cl. CPC G06F 30/394; G06F 30/31; G06F 2115/02

(57) ABSTRACT

Designing a network-on-chip (NoC) includes accessing an existing NoC topology having existing NoC elements, blockages and existing wire connections. The existing NoC elements include network interface units and switches. The designing further includes creating an updated NoC topology from the existing NoC topology, including adding at least one new wire connection to the existing wire connections. The designing further includes identifying turns and segments in the existing and new wire connections in the updated NoC topology; and ensuring that no cycles are created by the segments that form turns. The updated NoC topology is deadlock-free.

### CROSS REFERENCE TO RELATED APPLICATION

This application claims the benefit under 35 U.S.C. 119(e) of U.S. Provisional Application Ser. No. 63/666,247 filed on Jul. 1, 2024 and titled SYSTEM AND METHOD FOR SEGMENT REPLACEMENT IN AN INCREMENTAL TOPOLOGY GENERATION by Amir CHARIF et al., the entire disclosure of which is incorporated herein by reference.

### TECHNICAL FIELD

The present technology is in the field of electronic computer aided design of electronic systems and, more specifically, related to topology synthesis of a network-on-chip (NoC).

### BACKGROUND

Network-on-chip technology is being used at many semiconductor companies to support an ever-increasing number of cores on a single chip and satisfy a demand for ever-increasing processing power related to artificial intelligence (AI) and other applications. A NoC is superior to old point-to-point connectivity by way of a more scalable communication architecture that makes use of packet transmissions.

During design of a NoC, a NoC topology is generated. A NoC topology refers to a general layout of NoC elements (e.g., network interface units, buffers, switches, pipes, probes, firewalls, and adapters) and electrical connections between the NoC elements. The NoC topology significantly influences latency and power consumption. It also affects network traffic distribution.

Multiple iterations of the NoC topology may be generated until certain criteria are satisfied. An iteration may involve modification of the NoC topology.

Modification of a NoC topology can result in a potential deadlock. Types of deadlocks include routing-dependent deadlocks, and message-dependent deadlock.

If a deadlock occurs in a NoC during runtime, the deadlock can put the NoC in a stalled state without possibility of progress. The deadlock can be resolved by resetting the NoC. However, resetting the NoC is not desirable.

### SUMMARY

In accordance with various embodiments and aspects of the invention, a computer-implemented method for designing a network-on-chip (NoC) includes accessing an existing NoC topology having existing NoC elements, blockages and existing wire connections. The existing NoC elements include network interface units and switches. The method further includes creating an updated NoC topology from the existing NoC topology, including adding at least one new wire connection to the existing wire connections; identifying turns and segments in the existing and new wire connections in the updated NoC topology; and ensuring that no cycles are created by the segments that form turns. The updated NoC topology is deadlock-free.

In accordance with various embodiments and aspects of the invention, an electronic computer aided design (ECAD) tool includes computer-readable memory encoded with code for designing a NoC topology. The code, when executed by a computer system, causes the computer system to access an existing NoC topology having existing NoC elements, blockages and existing wire connections. The existing NoC elements include network interface units and switches. The code, when executed, further causes the computer system to create an updated NoC topology from the existing NoC topology, including adding at least one new wire connection to the existing wire connections; identify turns and segments in the existing and new wire connections in the updated NoC topology; and ensure that no cycles are created by the segments that form turns. The updated NoC topology is deadlock-free.

In accordance with various embodiments and aspects of the invention, an ECAD tool to generate a deadlock free network-on-chip (NoC) includes a non-transitory computer readable medium for storing code, which when executed by one or more processors, causes the tool to identify a region within a NoC topology for incremental optimization; identify routes in the same direction that can be reused; identify routes to be eliminated and mark the routes to be eliminated; and determine whether any route that is marked would result in a deadlock due to an external dependency.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1A illustrates an example network-on-chip (NoC) including various NoC elements.

FIG. 1B illustrates a method of designing a NoC in accordance with various aspects and embodiments of the invention.

FIG. 1C illustrates a simple example of a NoC topology.

FIG. 2A illustrates a method for generating a NoC description based on a set of constraints in accordance with various aspects and embodiments of the invention.

FIG. 2B illustrates a block diagram of a NoC synthesis tool in accordance with various aspects and embodiments of the invention.

FIG. 2C illustrates a computer-implemented method of modifying a NoC topology that avoids deadlocks in accordance with various aspects and embodiments of the invention.

FIG. 2D illustrates a computer system in accordance with various aspects and embodiments of the invention.

FIG. 3 illustrates an example floorplan onto which a NoC will be implemented.

FIG. 4 illustrates a connectivity table for a NoC and a table with flags that enable specific communication policies for different traffic classes.

FIG. 5 illustrates scenario tables with throughput definitions for read and write transactions.

FIG. 6 illustrates creation of an initial NoC topology in accordance with the various aspects and embodiments of the invention.

FIG. 7 illustrates decomposition of main switches of the initial NoC topology of FIG. 6 into mergers and splitters in accordance with the various aspects and embodiments of the invention.

FIG. 8 illustrates a roadmap for an initiator NIU in the NoC topology of FIG. 6 in accordance with the various aspects and embodiments of the invention.

FIG. 9 illustrates a roadmap for a target NIU in the NoC topology of FIG. 6 in accordance with the various aspects and embodiments of the invention.

FIG. 10 illustrates decomposition of a main splitter into a cascade of splitters distributed physically along a splitter roadmap in accordance with the various aspects and embodiments of the invention.

FIG. 11 illustrates decomposition of a main merger into a cascade of mergers distributed physically along a merger roadmap in accordance with the various aspects and embodiments of the invention.

FIG. 12 illustrates an example of two neighboring switches that are fused in accordance with the various aspects and embodiments of the invention.

FIG. 13 illustrates a NoC subnetwork having segments and turns in accordance with the various aspects and embodiments of the invention.

FIGS. 14A, 14B, 14C and 14D illustrate segment splitting in accordance with the various aspects and embodiments of the invention.

FIG. 15 illustrates a method for incremental synthesis of a NoC topology in accordance with the various aspects and embodiments of the invention.

FIG. 16A illustrates a subnetwork prior to a request for connecting element_S to element_D.

FIG. 16B illustrates a subnetwork resulting from a routing configuration from element_S to element_D in accordance with the various aspects and embodiments of the invention.

FIG. 17A illustrates a subnetwork in which wire length is optimized in accordance with the various aspects and embodiments of the invention.

FIG. 17B illustrates a subnetwork in which low latency communication is optimized in accordance with the various aspects and embodiments of the invention.

FIG. 18A illustrates an incremental synthesis mode for initial setup of segments in accordance with the various aspects and embodiments of the invention.

FIG. 18B illustrates an incremental synthesis mode for physical immutability of segments in accordance with the various aspects and embodiments of the invention.

FIG. 18C illustrates an incremental synthesis mode for logical immutability of segments in accordance with the various aspects and embodiments of the invention.

FIG. 18D illustrates an incremental synthesis mode for mutability of NoC elements in accordance with the various aspects and embodiments of the invention.

FIGS. 19 and 20 illustrate incremental synthesis applied to a mesh custom subnetwork description in accordance with the various aspects and embodiments of the invention.

FIG. 21 illustrates a method of using a custom subnetwork description in accordance with the various aspects and embodiments of the invention.

FIG. 22 illustrates a NoC topology having non-optimal wire connections.

FIG. 23A and FIG. 23B illustrate a NoC subnetwork before and after, respectively, wire optimization in accordance with the various aspects and embodiments of the invention.

FIG. 24A, FIG. 24B and FIG. 24C illustrate incremental synthesis involving insertion of one or more NoC elements in accordance with the various aspects and embodiments of the invention.

FIG. 25A and FIG. 25B illustrate incremental topology synthesis involving missing switches and segments marked for replacement in accordance with the various aspects and embodiments of the invention.

FIG. 26A, FIG. 26B, FIG. 26C and FIG. 26D illustrate a NoC subnetwork that has an external dependency and that is modified to avoid a potential deadlock in accordance with the various aspects and embodiments of the invention.

FIG. 27A, FIG. 27B, and FIG. 27C illustrate a NoC subnetwork including a passage point in accordance with the various aspects and embodiments of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention.

Appearances of the phrases “in accordance with one or more embodiments,” “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future.

As used herein, a “master” and a “initiator” refer to similar intellectual property (IP) modules or units and the terms are used interchangeably within the scope and embodiments of the invention. As used herein, a “slave” and a “target” refer to similar IP modules or units and the terms are used interchangeably within the scope and embodiments of the invention.

As used herein, a NoC element refers to a distribution point and/or a communication endpoint in a NoC that is capable of creating, receiving, and/or transmitting information over a communication path or channel. NoC elements may include, without limitation, network interface units (NIUs), switches, buffers, and adapters.

As used herein, splitters and mergers are switches, but not all switches are splitters or mergers. As used herein and in accordance with the various aspects and embodiments of the invention, the term “splitter” describes a switch that has a single ingress port and multiple egress ports. As used herein and in accordance with the various aspects and embodiments of the invention, the term “merger” describes a switch that has a single egress port and multiple ingress ports.

The following examples describe electronic computed aided design of a NoC for an electronic system implemented in a system-on-chip (SoC). An SoC includes initiators and targets, which communicate via a NoC. Examples of the initiators include central processing units (CPUs), graphics processing units (GPUs), video cards, accelerators, and direct memory access (DMA) controllers. Examples of the targets include volatile memory, persistent memory, and peripherals.

During operation of an SoC, an initiator may send a request transaction to a target using an address to select the target. Examples of request transactions include write requests and read requests. The NoC decodes the address and transports the request transaction to the target. The target handles the request transaction and sends a response transaction back to the initiator via the NoC. Such communication is based on the transmission of packets.

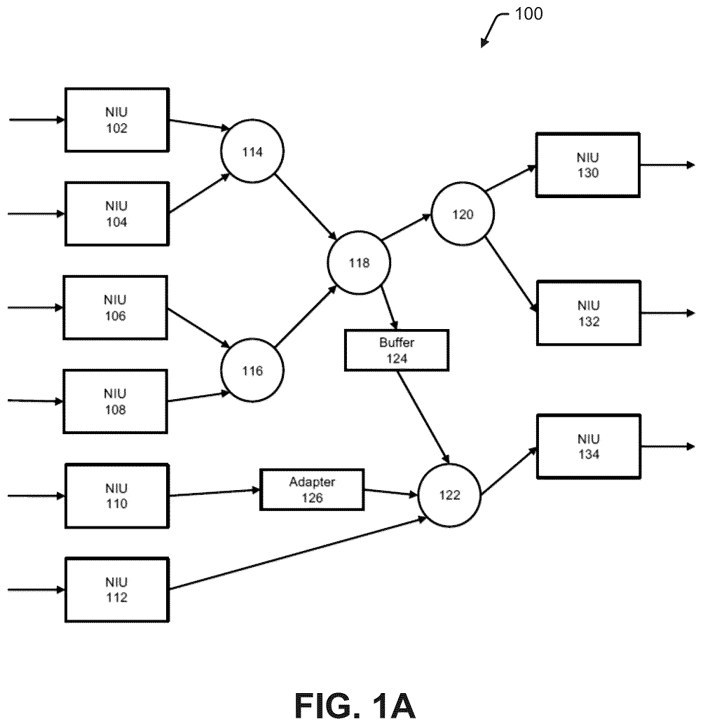

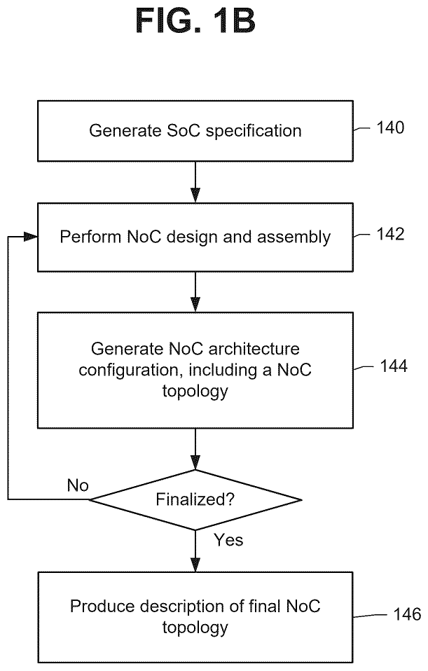

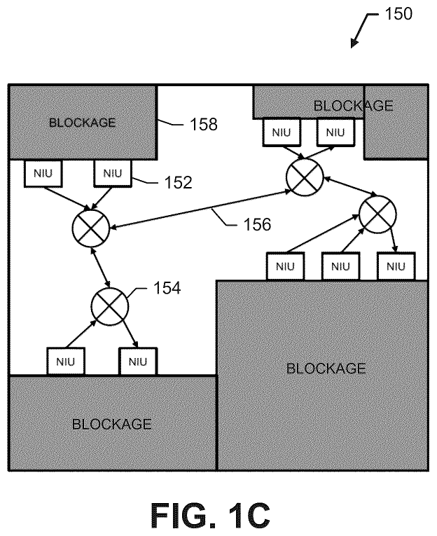

Referring now to FIG. 1A, an example network-on-chip (NoC) 100 is shown. The NoC 100 includes network interface units (NIUs) 102,104, 106,108, 110, 112, 130, 132, and 134. NIUs connected to initiators are referred to as initiator NIUs or INIUs, and NIUs connected to targets are referred to as target NIUs or TNIUs. The NIUs 102,104,106,108, 110, 112, 130, 132, and 134 convert the protocols used by their connected initiators and targets into the transport protocol used inside the NoC 100.

The NoC 100 further includes switches such as switches 114, 116, 118,120, and 122; adapters, such as adapter 126; and buffers, such as buffer 124. The switches 114, 116, 118,120, and 122 route flows of traffic between the initiators and the targets. The buffers insert pipelining elements to span long distances, or to store packets to deal with rate adaptation between fast senders and slow receivers or vice-versa. The adapters handle various conversions between data width, clock domains, and power domains.

Reference is now made to FIG. 1B, which illustrates a general method of designing a NoC. At block 140, an SoC specification is generated. The SoC specification provides a chip definition, technology, domains and layout for an SoC. The SoC specification also defines the real estate for the NoC and other NoC constraints. The SoC layout may include the locations of initiators and targets.

At block 142, NoC design and assembly are performed. IP blocks are selected from a NoC library, and the selected IP is instantiated. In addition, IP connection and assembly, sockets configuration, and end-to-performance capture may be performed. This stage produces a NoC specification that defines SoC IPs and their related sockets and protocols, along with the communication flows between initiators and targets, and memory maps.

At block 144, an architecture configuration of the NoC is generated. This includes NoC topology synthesis: generating a NoC topology and modifying the NoC topology in accordance with a method herein. NoC elements such as switches, buffers, firewalls, pipelines and rate adapters are added to the NoC topology. Power, Performance and Area (PPA) tradeoffs may be performed (unit duplication is decided together with size of buffers in switches for example).

Generating the architecture configuration is an iterative process. A loop from block 144 back to block 142 helps in finalizing the architecture configuration by changing the settings of parameters, changing connectivity schemes (e.g., from a mesh to crossbar or modified mesh), enabling of safety through unit duplication, etc.

A NoC design may have to satisfy different performance requirements, such as connectivity and latency between source and destination, frequency of various NoC elements, maximum area available for NoC logic and its associated routing (wiring), minimum throughput between initiators and targets, power consumption requirements, and positions. Multiple iterations of the NoC topology may be generated until the different performance requirements are satisfied.

At block 146, a final NoC topology description is produced, for instance, in a computer-readable file or done through a user interface, in graphical or textual form. The description may be stored in computer memory, ready for use by software.

Referring now to FIG. 1C, a NoC topology 150 is shown with various NoC elements, such as NIUs 152 and switches 154. The NoC topology 150 shows various connectivity elements 156 through various switches 154. The NoC topology 150 also shows constraints such as blockage areas 158 (that is, areas where the NoC elements cannot be placed and wire connections cannot be routed).

Reference is now made to FIG. 20, which shows a computer-implemented method of deadlock-free modification of a NoC topology. At block 200, an existing NoC topology is accessed. The existing NoC topology includes existing NoC elements, such as NIUs and switches. The existing NoC topology further includes blockages. The existing topology may or may not include existing wire connections. The existing NoC technology may be accessed, for example, by generating an initial NoC topology or retrieving an existing NoC topology from memory.

At block 202, an updated NoC topology is created from the existing NoC topology. The existing NoC topology is imported into the updated NoC topology, and at least one new wire connection is added to the existing wire connections. In some instances, the addition of at least one new wire connection might result from wire elimination and sharing. In some instances, the addition of at least one new wire connection might result from inserting NoC elements and passageways. Examples of such modifications are provided below.

At block 204, the existing and new wire connections in the updated NoC topology are characterized as segments and turns. Examples of turns are provided below.

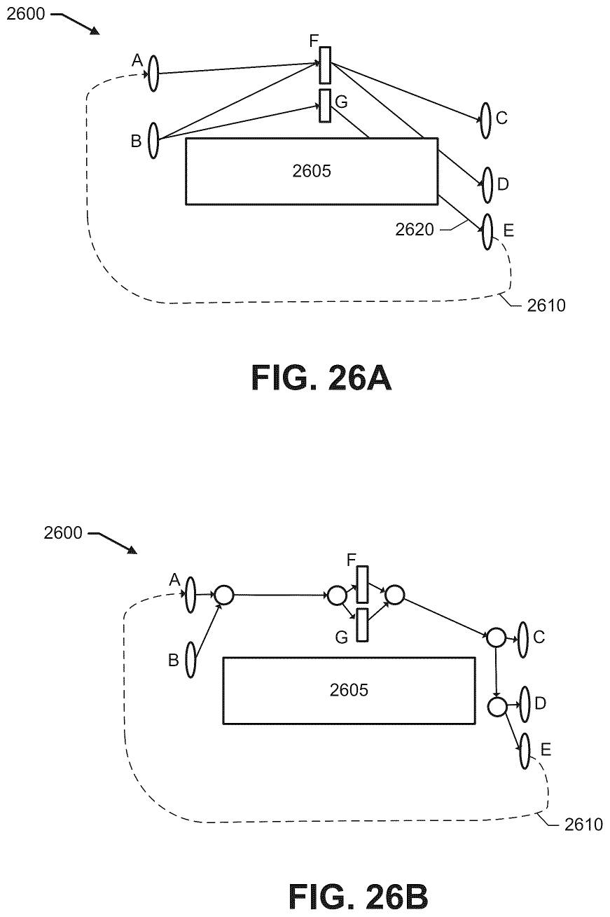

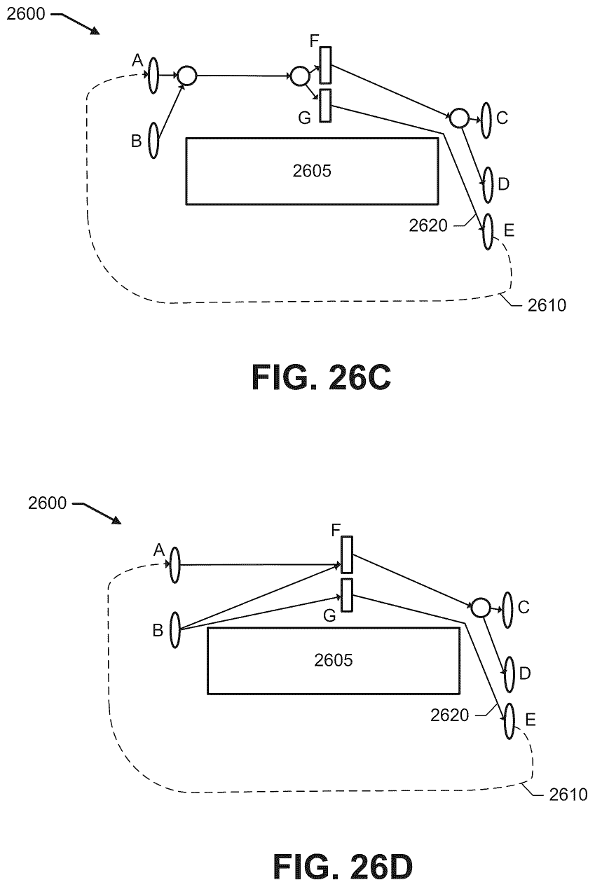

At block 206, it is determined whether any cycles are created by the segments that form turns. A potential deadlock-causing cycle may be formed by a path leaving an egress port of a NoC element and ultimately returning back to an ingress port of the NoC element. Cycles caused by an external dependency between NIUs is illustrated in FIGS. 26B and 26C.

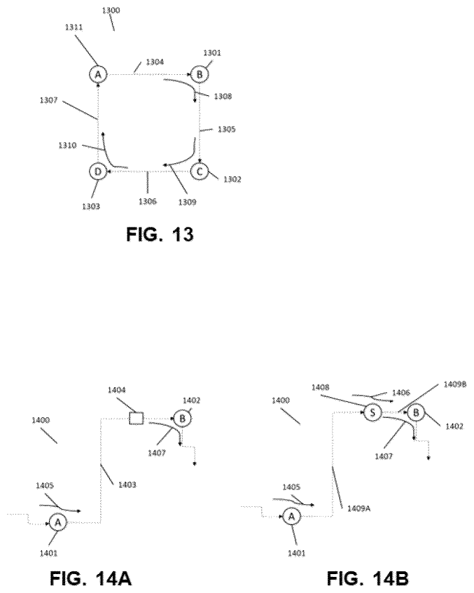

However, a cycle might not involve NIUs, and might involve only switches. See FIG. 13, for example, where a packet could travel from element_A to element_B to element_C to element_D and back to element_A.

If no cycles exist, the updated NoC topology is deadlock-free in view of the modifications (block 208). Additional modifications may be made by returning control to block 202.

If a cycle is identified, the cycle may be broken (block 209). As a first example, the cycle may be broken by performing segment splitting to create sub-segments with variable routes. As a second example, a new candidate connection is considered for addition to the updated NoC topology. If that new candidate connection creates a cycle or cyclic dependency, it is eliminated from consideration. Additional modifications may be performed by returning control to block 202.

In some instances, a given segment may be split at a point that is within a threshold distance from a switch at an endpoint of the given segment. In that event, the endpoint is connected to the switch. This is done to avoid adding a new switch and new sub-segment to connect split segments.

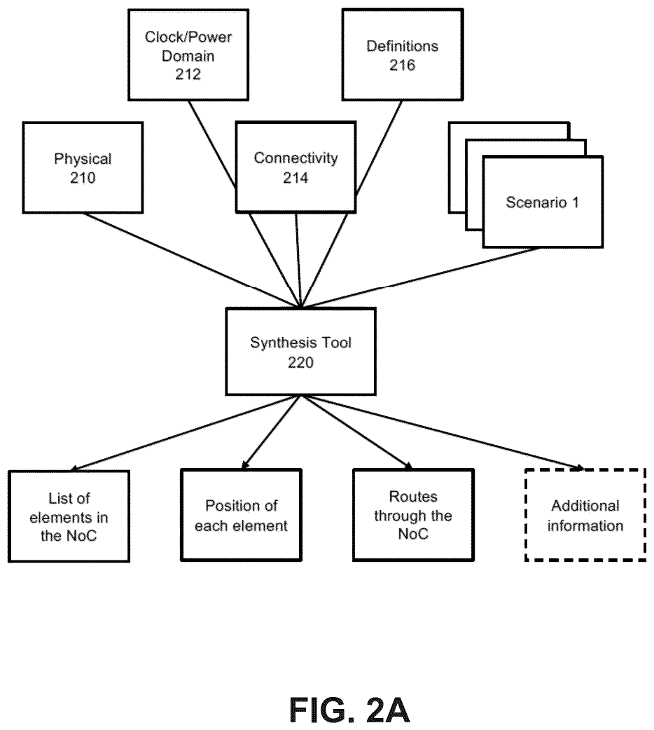

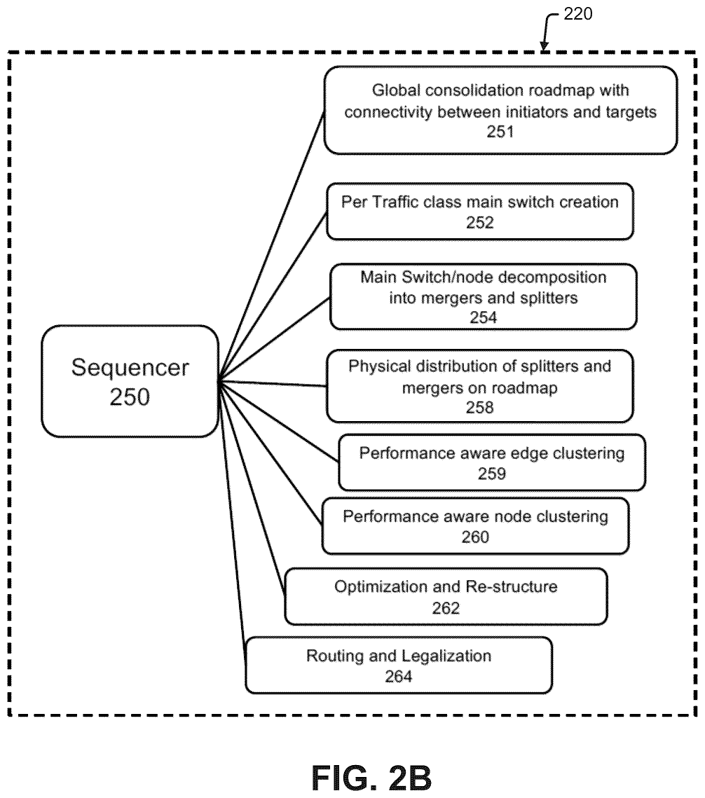

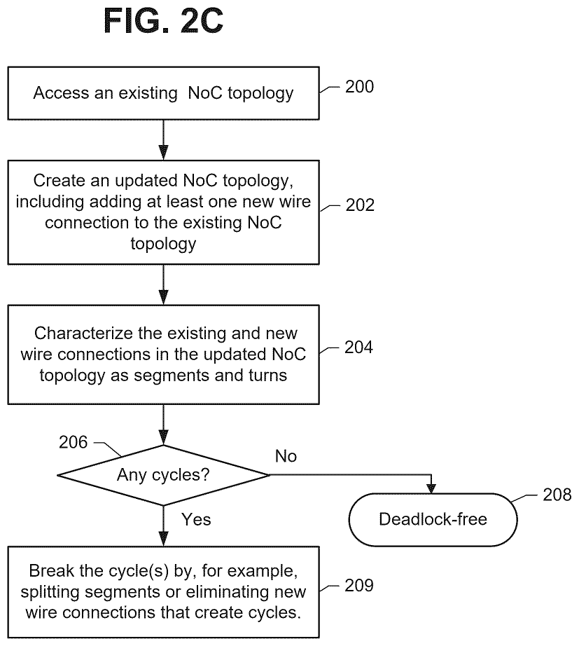

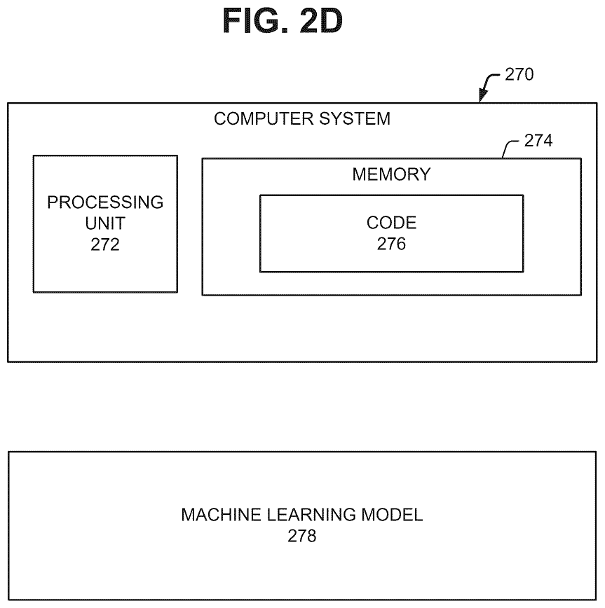

The computer-implemented method of FIG. 2C avoids deadlocks in a computationally efficient manner. Potential deadlocks are identified with each update of a NoC topology. The potential deadlocks are resolved during NoC synthesis rather than resolving deadlocks in a NoC during runtime. Resolving the potential deadlocks during synthesis of the NoC topology improves performance of an SoC during runtime because it increases data throughput of the NoC during runtime. Resolving the potential deadlocks during NoC synthesis also eliminates the need to shut down and restart the SoC to resolve a real deadlock during runtime.

In some embodiments, the modifications at block 202 may be made algorithmically. In other embodiments, the modifications at block 202 may be made by a trained machine learning (ML) model. For instance, the ML model may be trained to identify regions where wires may be eliminated and shared, and it may be further trained to implement wire elimination and sharing. The ML model may be trained to insert NoC elements and passageways and make wire connections to the inserted NoC elements and passageways.

The ML model may be trained on previous NoC topologies generated by the method of FIG. 2C. Feedback from block 206 may be used as training data to teach the ML model to make wire connections that avoid deadlocks. For instance, a large generative ML model such as a Transformer model may be pre-trained to make modifications to a NoC topology without regard to deadlocks. The large generative ML model may be fine-tuned (e.g., weights at certain layers may be updated, one or more layers may be added) with a cost function to penalize NoC topology modifications that create deadlocks. The feedback from block 206 may be used as training data for the fine-tuning.

Reference is made to FIG. 2D, which illustrates elements of a computer system 270 for implementing a method herein. The computer system 270 includes a processing unit 272 and computer-readable memory 274 encoded with code 276 that, when executed, causes the computer system 270 to perform deadlock-free modification of an existing NoC topology according to a method herein. In some embodiments, the code 276 may be part of a standalone application, such as an electronic computer aided design (ECAD) tool. In some embodiments, the code 276 may be integrated into a larger program that also performs a method herein.

For those embodiments that utilize an ML model 278, the ML model 278 may be accessed from a remote site. In the alternative, the ML model 278 may be stored in and accessed from the computer-readable memory 274.

The computer system 270 may also be used to train or fine-tune the ML model 278. For instance, the computer system 270 may store data obtained at block 206 of FIG. 2C. The stored data may be used for the training or fine-tuning.

Reference is now made to FIG. 2A, which shows an ECAD synthesis tool 220 for synthesizing a NoC topology according to a method herein. A set of constraints 210, 212, 214, and 216, and a set of scenarios are provided to the synthesis tool 220. As used herein, a “scenario” defines an expected performance in term of throughput of data between an initiator and a target.

A designer or user may build the set of constraints 210, 212, 214, and 216. The constraints may be provided to the synthesis tool 220 in machine-readable form, such as computer files using a defined format to capture information, that is understood and processed by the synthesis tool 220. Examples of the format include, but are not limited to, Extensible Markup Language (XML) and JavaScript Object Notation (JSON).

In some embodiments, the performance and function of the synthesis tool 220 may include third-party ASIC implementation tools such as logic synthesis, place and route back end tools. In some embodiments, the synthesis tool 220 includes or accesses a machine learning model that aids in the NoC topology synthesis.

Referring additionally to FIG. 2B, the synthesis tool 220 reads the files containing the description of the constraints and scenarios and performs NoC synthesis. In some embodiments, the NoC synthesis is broken down into multiple steps. A sequencer 250 is responsible for executing each step of the NoC synthesis in view of the constraints 210, 212, 214, and 216.

In some embodiments, the sequencer 250 may also execute each step of the NoC synthesis in further view of one or more various inputs. These various inputs may include, without limitation, input 251 that includes global consolidation roadmaps with connectivity between initiators and targets including roadmap creation and information between each initiator and target; input 252 that includes traffic classification and main switch creation; input 254 that includes main switch decomposition into mergers and splitters; input 258 that includes information about physical distribution of splitters and mergers in the roadmap; input 259 that includes information about edge clustering; and input 260 that includes information about performance-aware node clustering. The various inputs may further include input 262 that includes information about optimization and restructuring. The various inputs may further include input 264 that provides information about routing and legalization. The sequencer 250 may use one or more of the inputs 251-264 to synthesize the NoC topology.

The global consolidation roadmap (from input 251) may include a consolidation model that captures the global physical view of the connectivity of the topology's free space, as well as the connectivity across/between the initiators and targets. The global consolidation roadmap may be modeled by a graph of physical NoC elements and canonical segments that are used to position the NoC elements during synthesis of the NoC topology. The global consolidation roadmap may be used to hasten computation. The global consolidation roadmap may be stored in persistent memory so it can be exported and re-consumed for incremental synthesis and subsequent runs.

Edge clustering information (from input 259) may be used to minimize resources and enhance performance goals through proper algorithms and techniques. In some embodiments, edge clustering may be applied in conjunction and in cooperation with node clustering (from input 260). Edge clustering and node clustering may be used in combination by mixing, by being applied concurrently, or by being applied in sequence. An advantage and goal is to expand the spectrum of synthesis and span a larger solution space for the NoC.

Re-structuring information (from input 262) includes a variety of transformations and capabilities. The transformations are considered logical if there is a change in structure of the NoC topology. The transformations are considered physical if there is a physical change in the NoC topology, such as moving a NoC element to a new location. Other examples of restructuring include, but are not limited to, breaking a NoC element into smaller NoC elements, reparenting between NoC elements, sub-part duplication to avoid deadlocks and reduce congestion, and physically re-routing wire connections to avoid congestion areas or meet timing constraints.

The following paragraphs provide examples of NoC generation and modification. The following paragraphs also provide examples of detecting cycles and avoiding deadlocks. In some of the examples, the same reference may be used for an initiator or an NIU connected to an initiator. Thus “M1” may refer to initiator M1 or the NIU connected to initiator M1. Similarly, the same reference may be used for a target or an NIU connected to a target. Thus “S1” may refer to target S1 or the NIU connected to target S1.

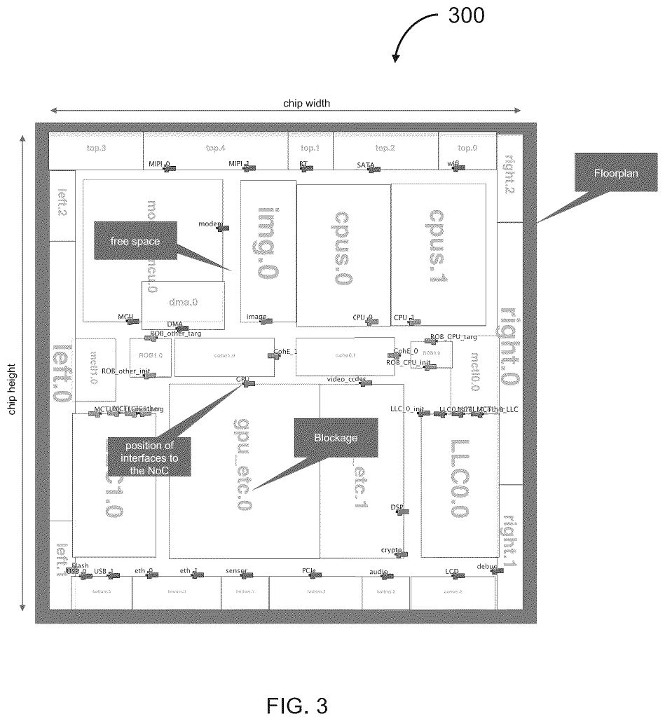

Referring now to FIG. 3, which shows an example floorplan 300 of an SoC onto which a NoC will be implemented. The floorplan 300 identifies positions for various initiators, INIUs, targets, and TNIUs. The physical constraint 210 of FIG. 2A provides physical information about the design that includes the size of the SoC onto which the NoC will be implemented, the various blockage areas in which the NoC elements are not allowed to be placed, free space, and the positions of the interfaces, such as positions of the initiator NIUs and the target NIUs. The free space refers to area of SoC where the NoC elements are allowed to exist and is defined by area not covered by the blockages.

The initiators and targets of an SoC may be characterized by many different parameters. Some parameters might define data bus widths for wire connections used to send write requests and receive write responses. Other parameters might include, but are not limited to, wire delay and/or logic density, clock domain crossing (CDC), performance requirements, connectivity requirements, and communication policy.

Parameters may also define clock and power domains to which the initiators and targets belong. A clock domain is defined by the logic fed by a given clock input. The clock input may characterized by clock frequency. A power domain is defined by all logic getting power from the same power source. If a power source is gated, a power domain can be isolated from other power domains.

The SoC may include multiple clocks domains and multiple power domains. The clock and power domain constraints 212 of FIG. 2A may include areas on the SoC where logic belonging to a particular domain is allowed to be placed.

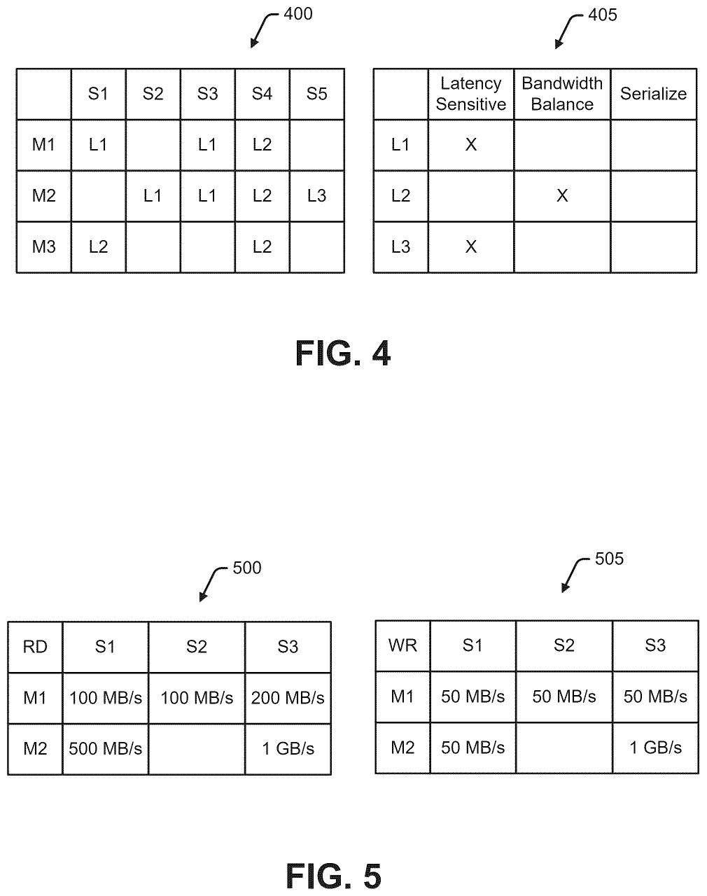

Continuing with FIG. 2A and FIG. 2B and referring additionally to FIG. 4, an example connectivity table 400 may be used to specify connectivity constraints 214. In some embodiments, the connectivity table 400 allows for traffic to be defined by classification. The connectivity table 400 enables the use of a traffic class label for each connection between an initiator and a target. In the example connectivity table 400, there are three traffic classes labeled as L1, L2, and L3. A traffic class label is an arbitrary label, chosen by the user or designer. The number of labels that can be defined is not limited to a specific number. Each label represents the need for independent network resources. The synthesis tool 220 may assign a distinct subnetwork, which can be physically different, or virtual networks, if supported by the underlying NoC technology.

A precise definition of the target that can receive requests from an initiator is outlined or set forth in the connectivity table 400. As shown in the connectivity table 400, an initiator is not required to send requests to all of the targets.

In the connectivity table 400, each initiator is assigned a row and each target is assigned a column. If a given initiator is specified to send traffic to a given target, a traffic class label is presented at the intersection of the given initiator row and the given target column. If no label is present at the intersection, then there is no connectivity between that given initiator and that given target. For example, initiator M1 is connectively communicating with target S1 per a defined label L1. However, initiator M1 does not communicate with target S2, and hence there is no label at the intersection of initiator M1 and target S2. Other embodiments may use a different format to represent connectivity, as long as each initiator-target combination has a precise definition of its traffic class, or no classification label if there is no connection.

Table 405 provides an example of communication policies for the different traffic classes. In the example, the communication policy definition for traffic class label L1 is latency sensitive, and the communication policy definition for traffic class label L3 is latency sensitive and balanced bandwidth. No flags are checked for traffic class label L2.

Referring now to FIG. 5, tables 500 and 505 provide information about a scenario (shown in FIG. 2A) for read (RD) and write (WR) transactions, respectively. Each scenario describes an expected required read bandwidth and an expected required write bandwidth between each initiator and each target. Throughput may be defined in bytes-per-second (B/s). A typical SoC may have multiple modes of operation and, therefore, multiple scenarios. As an example, an SoC for a smartphone has a gaming mode of operation, an audio call mode of operation, and an idle mode of operation. These different modes of operations define scenarios that depend on different throughput rates. Thus, each set of scenarios represents a different mode of operation of the SoC supports. Moreover, each set of scenarios represents the expected NoC minimum performance in terms of throughput between initiators and targets.

The tables 500 and 505 include information that defines various throughput rates of a scenario. Table 500 defines read throughputs, and table 505 defines write throughputs. The actual format used to represent a scenario can be different, as long as each pair of initiator and target has a precise definition of its minimum required throughput for read and for write. In table 500, a read transaction from initiator M1 to target S1 has a minimum performance throughput of 100 MB/s. In table 505, a write transaction from initiator M1 to target S1 has a minimum throughput of 50 MB/s. Empty cells indicate no connection. The tables 500 and 505 indicate that there is no connection between initiator M2 and target S2.

In some embodiments, the synthesis tool 220 may use read throughput requirements to size the response network, which handles response transactions going from target to initiator. The synthesis tool 220 may use write throughput requirements to size the request network, which handles request transactions going from initiator to target.

If scenarios are not defined for the synthesis tool 220, the synthesis tool may perform optimization based on other costs. For example, the synthesis tool 220 may optimize the NoC topology for physical cost, such as lowest gate cost and/or lowest wire cost.

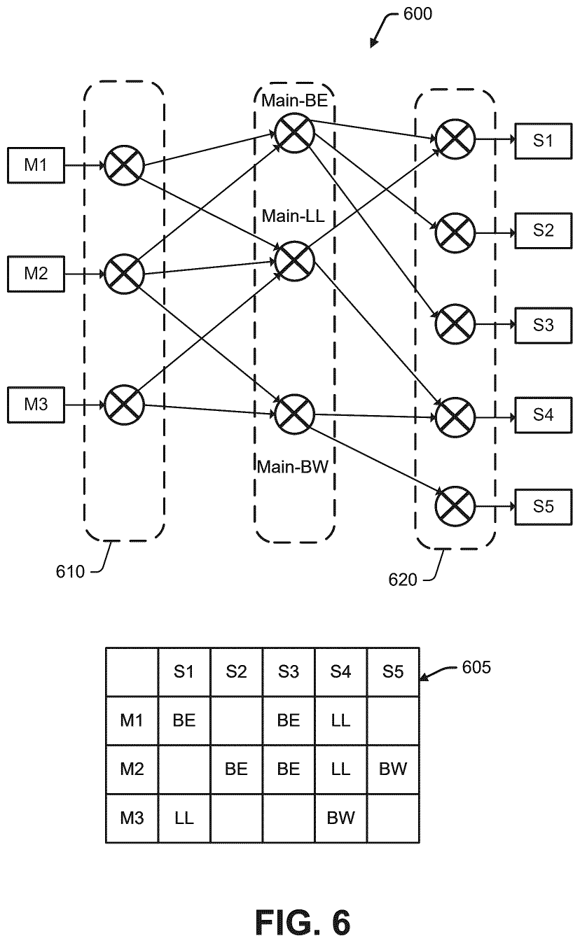

FIG. 6 illustrates an example of creating an initial NoC topology 600. The initial NoC topology 600 implements a connectivity table. For example, the initial NoC topology 600 implements the connectivity table 605 with the following defined parameters and NoC elements:
one initiator NIU per initiator;
one target NIU per target;
one switch per defined traffic class, called the main switch of the class;
one switch after each initiator NIU to route traffic to those main switches that the corresponding initiator needs to reach, and
one switch before each target NIU to merge traffic from the different main switches that are sending traffic to that target.

In the example of FIG. 6, the connectivity table 605 indicates three traffic class labeled as BE, LL and BW. The initial NoC topology 600 includes three initiator NIUs M1, M2 and M3, and five target NIUs S1, S2, S3, S4 and S5. Since there are three traffic classes, there are three main switches Main_BE, Main_LL and Main_BW. The initial NoC topology 600 further includes three switches 610 after the three initiator NIUs M1-M3, and five switches 620 before the five target NIUs S1-S5.

The synthesis tool 220 may compute data width of each switch, and the clock domain it belongs to, using the data width of each connected NIU, and their clock domain. With each step that transforms the NoC topology, the synthesis tool 220 may compute the data width and the clock domain of newly added NoC elements.

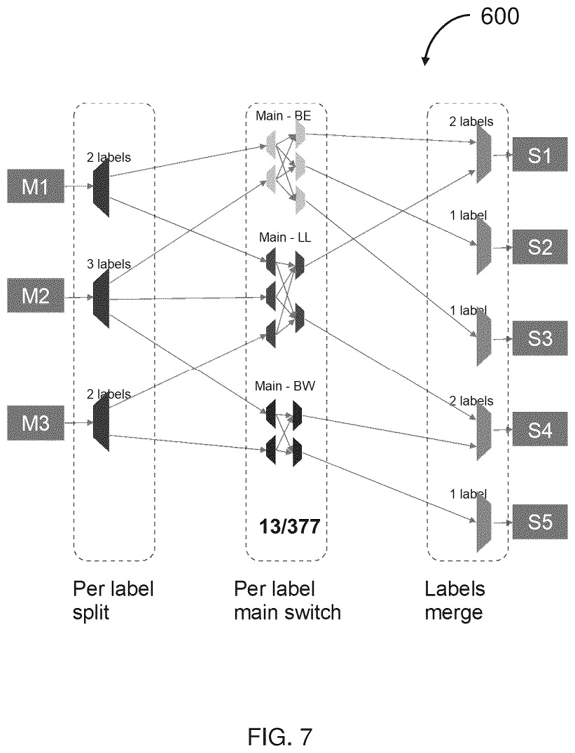

Reference is now made to FIG. 7. The synthesis tool 220 transforms the initial NoC topology 600 of FIG. 6. The transformations will be made in a way that the NoC topology 600 maintains its functionality and that location information is added to the NoC elements.

Input 254 to the sequencer 250 may represent main switch decomposition into mergers and splitters. The synthesis tool 220 decomposes each main switch of the initial NoC topology 600 into an equivalent implementation with splitters and mergers. Some main switches may have a single ingress port and multiple egress ports. Some main switches may have multiple ingress ports and a single egress port. During main switch decomposition, each main switch ingress port results in a splitter, and each main switch egress port results in a merger. The splitters and mergers created from each main switch are connected together according to the connectivity table 605.

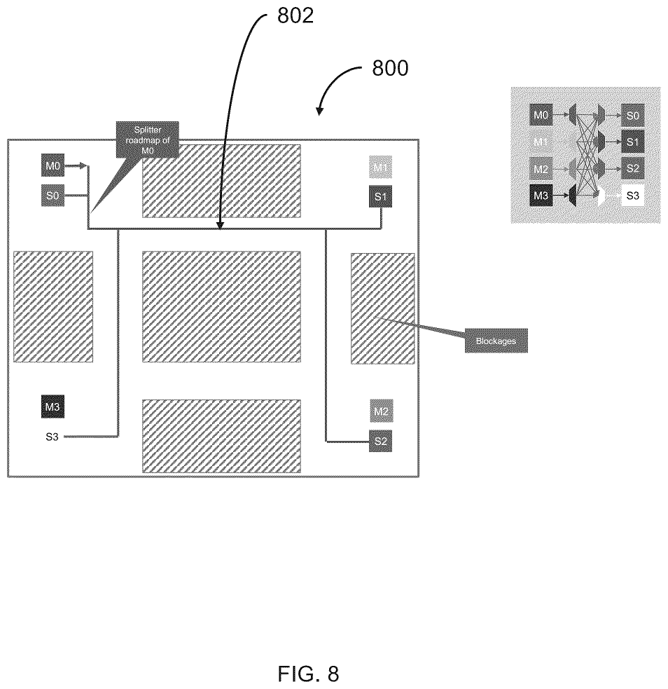

Reference is now made to FIG. 8, which shows a NoC topology 800. The input 256 of the sequencer 250 provides information about roadmap creation between each initiator and its connected target(s). FIG. 8 shows a physical path 802 for initiator NIU M0. This physical path 802, called a splitter roadmap, is computed between the initiator NIU M0 and each of its connected target NIUs S0, S1, S2, and S3. Although not shown in FIG. 8, a splitter roadmap is provided for each other initiator NIU M1, M2 and M3.

The synthesis tool 220 may use an algorithm to find a path between an initiator NIU and its connected target NIUs. The algorithm may attempt to find minimum path length.

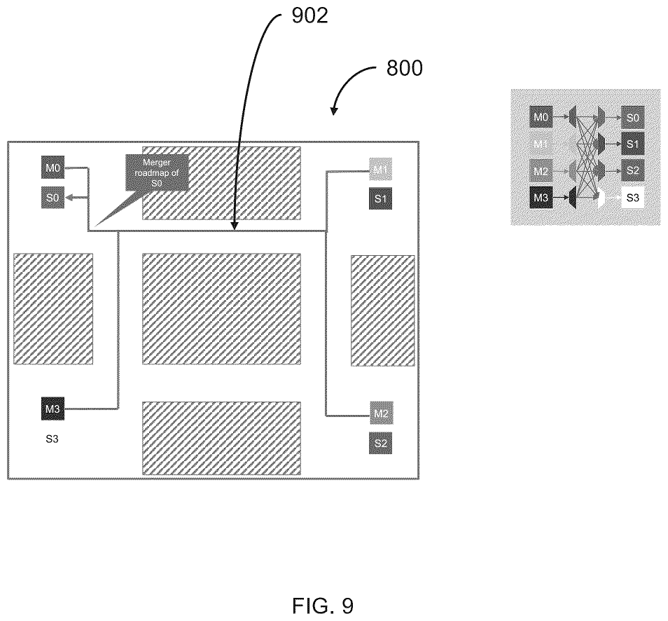

FIG. 9 shows the NoC topology 800 with a computed a physical path 902 between a target NIU S0 and each of its connected initiator NIUs M0, M1, M2 and M3. The physical path 902 is called a merger roadmap of the target NIU S0. Although not shown in FIG. 9, a merger roadmap is provided for each other target NIU S1, S2 and S3. The synthesis tool 220 may use an algorithm to find a physical path between a target NIU and its connected initiator NIUs. The algorithm may attempt to find minimum path length.

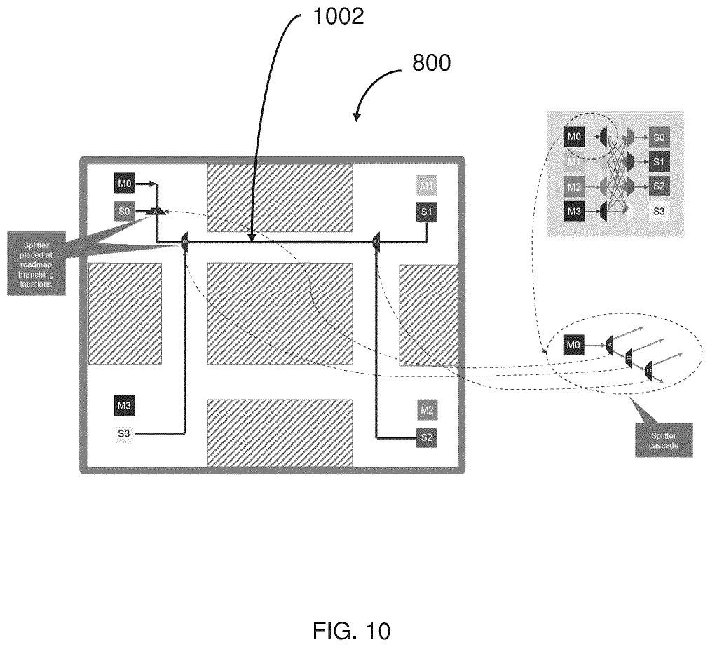

FIG. 10 shows the NoC topology 800 with a path 1002 after main switch decomposition. Input 258 to the sequencer 250 provides information about physical distribution of splitters and mergers on the merger roadmaps. The synthesis tool 220 decomposes each main switch into mergers and splitters. The synthesis tool 220 further decomposes each main splitter into a cascade of splitters. Each splitter of the cascade is placed on a branching point. FIG. 10 illustrates the branching points for path 1002 as each point where the path 1002 is split into two or more branches.

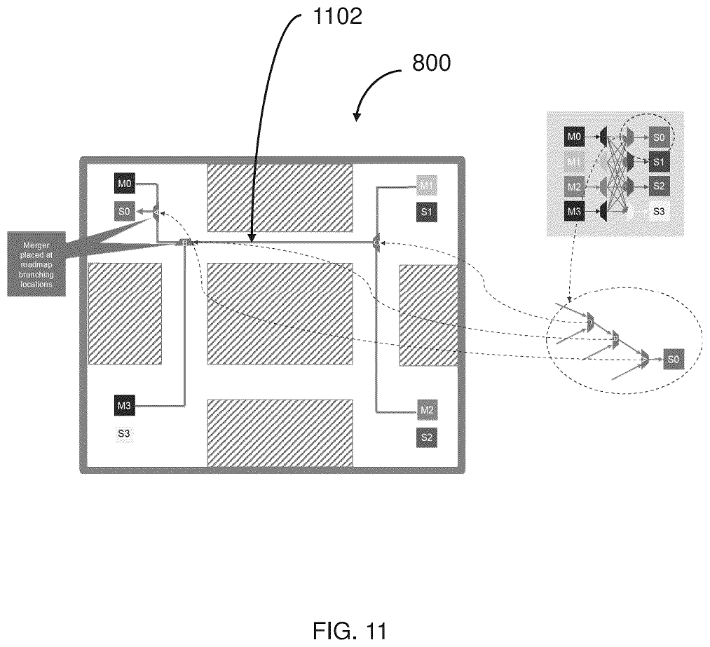

FIG. 11 shows the NoC topology 800 with a path 1102 corresponding to a merger roadmap. The synthesis tool 220 further decomposes each merger into a cascade of mergers. Each merger of the cascade is placed on a branching point of the merger roadmap. FIG. 11 illustrates the branching points for path 1102 as each point where the path 1102 is split into two or more branches.

The process of decomposing a splitter in a cascade of splitters preserves the original splitter functionality, as the number of inputs to the cascade is still one, and the number of outputs of the cascade is identical to the number of outputs of the original splitter. The process of decomposing a merger in a cascade of mergers preserves the original merger functionality, as the number of outputs of the cascade is still one, and the number of inputs to the cascade is identical to the number of inputs to the original merger. Advantageously, the decomposition results in a set of elementary switches that are physically placed close to where the actual connections between switches need to be.

Advantageously, the synthesis tool 220 transforms the NoC topology to reduce the number of wires used between switches, while keeping the performances (e.g., required minimum throughput between initiator and target) as defined in the scenarios. Advantageously, the switches may be clustered for performance-aware switching. Mergers and splitters that have been distributed on the roadmaps may be treated like ordinary switches.

The synthesis tool 220 may use an iterative process to fuse switches under the condition that performances are still met, Iterations are performed until no further switch fusion can occur. The iterative process may be performed as follows:

Select a candidate switch for fusion with one of its neighbors.

For a selected candidate, search for a neighbor to fuse with. The criteria for a neighbor may be based on evaluation of a cost function. The cost function may return a neighbor that is “best suited” for fusion. The definition of “best suited” may be implementation-dependent. The cost function may consider metrics such as wire length, logic area, power, and performance. Two switches may be fused if the gain in terms of at least one metric is maximized.

Determine whether fused switches meet all scenarios (e.g., all minimum throughput requirements are met). If not, then the fusion of the two switches is not allowed. Control is returned to (b) and a search for another neighbor is performed. If no more neighbors are found, the switches are left intact.

Return control to (a) and select another candidate switch until no candidate switches remain. All switches in the NoC topology are eventually selected as candidates for fusion.

In some embodiments, the synthesis tool 220 may ensure that the number of switches does not exceed a threshold e.g., (maximum number of ingress ports, maximum number of egress ports). If the threshold is exceeded, then fusion is not performed.

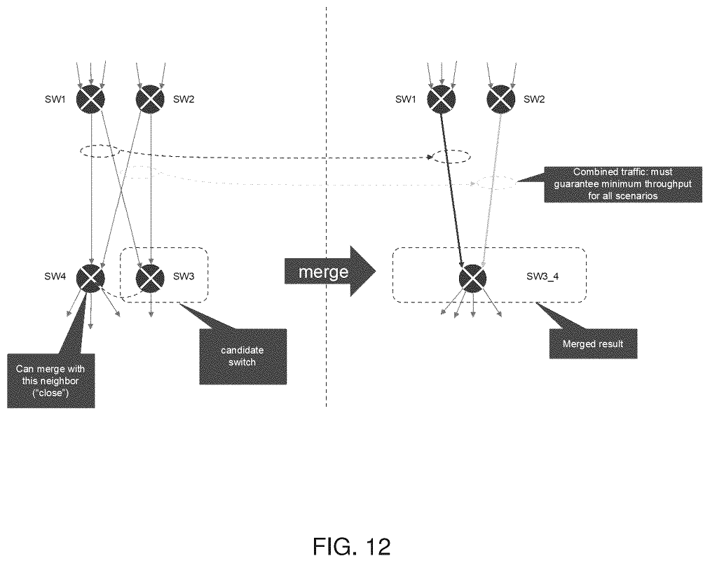

Reference is made to FIG. 12, which shows neighboring switches SW3 and SW4. Input 260 of the sequencer 250 provides information about performance-aware switching clustering. The synthesis tool 220 performs switch fusion as described above. Switch SW3 is selected as a candidate, and switch SW4 is identified as a neighbor. When the switches SW3 and SW4 are fused, the wire connections that were going from switches SW3 and SW4 are simplified into a single wire connection to the resulting single switch SW3_4. For example, a first wire connection from switch SW1 to switch SW3 and a second wire connection from switch SW1 to switch SW4 are combined into a single wire connection from switch SW1 to fused switch SW3_4. Advantageously, long connections between distant switches (e.g., switches SW1 and SW2) are removed and reduced to a minimum, while connections between neighboring switches are removed and made inside the switch themselves.

Referring again to FIG. 2B, input 262 to the sequencer 250 includes information about various optimizations that can be performed to further reduce the number of wire connections in the NoC topology, the area of the NoC elements, and power consumed by the NoC elements. Examples of such optimization include: detection of wire connections that can be removed because they are not used, or their traffic can be re-routed; reducing the width of a wire connection if the wire connection is wider than required by the scenarios; and performing wire length optimization through finding an optimal placement of all the NoC elements that minimizes the total wire length, where the total wire length of the NoC topology is the sum of the distance spanned by each wire connection between NoC elements times the width of that connection.

Input 264 to the sequencer 250 provides information about producing a legal NoC topology. The synthesis tool 220 can modify the locations of the NoC elements so that (a) the NoC elements fit within the free space and do not overlap, and (b) the NoC elements exist within their corresponding clock and power domain limits. The area occupied in the NoC topology by each NoC element may be computed using the information provided regarding the capabilities of the technology, such as the area of a reference logic gate. Then each NoC element may be tested for correctness of its placement (sufficient free space and no NoC element overlaps). If a NOC element fails the test, that NoC element is moved until a location that passes the test is found.

Reference is now made FIG. 13, which illustrates the use of turns and segments to identify deadlocks. NoC subnetwork 1300 is expressed in terms of a plurality of segments and turns. A segment represents a directed channel between two NoC elements. The subnetwork 1300 of FIG. 13 includes first, second, third and fourth segments 1304, 1305, 1306 and 1307. The first segment 1304 holds a physical path between element_A 1311 and element_B 1301. The second segment 1305 holds a physical path between element_B 1301 and element_C 1302. The third segment 1306 holds a physical path between element_C 1302 and element_D 1303. The fourth segment 1307 holds a physical path between element_D 1303 and element_A 1311. Each segment 1304, 1305, 1306 and 1307 has one or more associated cost metrics that may be utilized during synthesis and/or generation to track cost of certain routes.

As used herein, a turn is formed by a pair of segments. A plurality of turns may be utilized to identify deadlocks. Turns have a dependency between segments. FIG. 13 shows first, second and third turns 1308, 1309 and 1310. The subnetwork 1300 remains deadlock-free as long as no cycles are created by segments, given the allowed turn 1308, turn 1309, and turn 1310.

The presence of first turn 1308 from first segment 1304 to second segment 1305 indicates that a packet may be routed from first segment 1304 to the second segment 1305. The presence of second turn 1309 from second segment 1305 to third segment 1306 indicates that a packet may be routed from second segment 1305 to third segment 1306. The presence of third turn 1310 from third segment 1306 to fourth segment 1307 indicates that a packet may be routed from third segment 1306 to fourth segment 1307. If the third segment 1307 is split at any point of its physical route into two new segments, the subnetwork 1300 will be deadlock-free, as the packet exiting the third turn 1310 will not reach element_A 1311.

In some embodiments, the synthesis tool 220 may allow cycles to be created by the NoC elements. For instance, cycles may be allowed to exist and wire connections may be reused without causing deadlocks so that only necessary channels are allocated to prevent cycles. As a result, this eliminates unnecessary channels and reduces the associated wire cost associated therefrom.

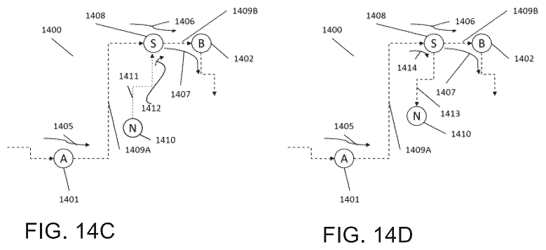

Reference is now made to FIGS. 14A-14D, which illustrate an example of segment splitting in NoC subnetwork 1400. FIG. 14A shows the subnetwork 1400 prior to splitting. Segment 1403 is defined by element_A 1401 to element_B 1402. The segment 1403 will be split at point 1404. A first turn 1405, a second turn 1406, and third turn 1407 are shown.

FIG. 14B shows the split of segment 1403 into a new first segment 1409A and a new second segment 1409B. Newly added element_S 1408 is located at point 1404. Newly added element_S may be, for example, a switch. New first segment 1409A goes from element_A 1401 to element_S 1408, and new second segment 1409B goes from element_S 1408 to element_B 1402.

The set of turns involving the split of segment 1403 is updated to use the two new segments 1409A and 1409B. The second turn 1406 is new. However, the third turn 1407 is preserved.

As shown in FIGS. 14C and 14D, the segment splitting and the addition of the switch (element_S 1408) enables new routes to be added and new turns to result.

FIG. 14C depicts new segment 1411 as a channel between element_S 1408 and new element_N 1410. The new element_N 1410 may include, for example, an IP block and/or an initiator. If segment 1411 is directed towards the new second segment 1409B, a new turn 1412 results.

FIG. 14D depicts new segment 1413 as a channel between new element_N 1410 and element_S 1408. If the first new segment 1409A is directed towards segment 1413, a new turn 1414 results.

Thus, a segment that has been split is no longer considered “as-is” because the split has resulted in sub-segments with variable routes. This recursive representation is advantageous for incrementality, as it ensures that segments which are part of existing routes and which may need to be split can still be recovered (as a succession of sub-segments) when re-constructing the existing routes.

In some embodiments, the synthesis tool 220 translates all existing routes of a NoC topology into segments and turns. As a result of the translation, the NoC topology is described as a set of at least one segment as defined by the physical path existing between two NoC elements. If the turns reveal the existence of one or more deadlocks in the NoC topology, the synthesis tool 220 may provide a “fail” notice.

The synthesis tool 220 may also extract a set of connections that does not have defined routes and/or a set of connections that need to be synthesized. The extracted set of connections may be sorted according to a heuristic.

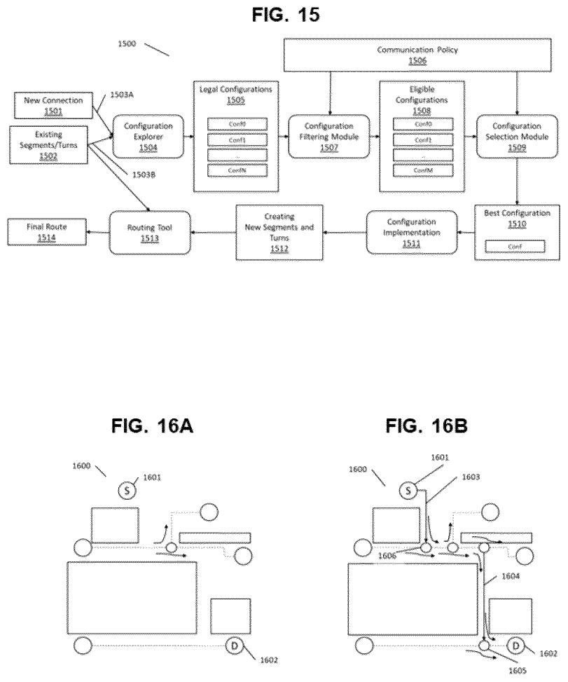

FIG. 15 illustrates method 1500 in which the synthesis tool 220 adds a new connection 1501 to an existing NoC topology having existing segments and turns. An input to a configuration explorer 1504 may be a new connection 1501 and/or an existing segment 1502. The new connection 1501 may cause the addition of new NoC elements, such as switches, which define a route from a first NoC element to a second NoC element. The existing segment 1502 may be re-expressed as at least one segment and/or a pair of segments having at least one turn. In some embodiments, the existing turns are not allowed to be changed. When the new connection 1501 is added, one or more turns associated with the new connection 1501 are added as well to complete a route from the first NoC element to the second NoC element. The synthesis tool 220 ensures that the added turns do not generate cycles and/or deadlocks with the existing turns. Not changing the existing turns and only considering the effects of the added turns is a more computationally efficient way of determining whether any cycles exist.

Configuration explorer 1504 receives a new connection at input 1503A and an existing segment at input 1503B. If there are a plurality of possible routes to connect the first NoC element to the second NoC element, the configuration explorer 1504 explores the possible routes subject to legal configurations 1505. Configuration explorer 1504 may be configured to explore possibilities indicating a location, traversing the segment, to split a segment. Configuration explorer 1504 may have a configuration with a new entry segment for connecting the first NoC element to an existing connection in the NoC topology. If the first NoC element is already connected, it already has an entry segment. Configuration explorer 1504 may create a new exit segment for the first NoC element.

The cost of a given route may be updated at each step according to communication policy 1506. For example, moving within an existing segment away from its destination may have more or less cost than creating a new segment that directly reaches the destination. The cost may depend on whether communication policy 1506 favors wire length and/or latency.

Existing segments and potential future segments may be identified and evaluated, for example, using a shortest path algorithm including, but not limited to, A* and/or Dijkstra. A given step in the shortest path algorithm considers the different points that can be reached from the current point. The current point is at least one point along the physical path of an existing segment. The path from the current point in the current segment to a subsequent point is subject to considerations.

In some embodiments, a path may advance one step along the current segment's path. In some embodiments, if the end of a segment's path has been reached, the path may advance to the first point in the path of another segment, such as a segment that is directly connected to the current segment, and which the current segment can form a turn with.

In some embodiments, if a destination is not connected, such as if no exit segment exists, the path may jump directly to the destination. This corresponds to creating a new exit segment. The new and/or future exit segment is then added to the configuration.

In yet other embodiments, a path may jump to any point of any segment, as long as the following conditions are satisfied. For example, no cyclic dependencies are created, the two segments have compatible communication policies, and the communication policy allows merging. If these conditions are satisfied, a new internal segment is added to the configuration.

Configuration filtering module 1507 may store a predetermined listing that contains data including, but not limited to, which configurations are legal, which configurations result in deadlocks, and which configurations are not optimal. Configuration filtering module 1507 may filter different configurations given multiple criteria including, but not limited to, communication policy-based criteria and/or any custom criteria and only keeps a sub-set. In an example of custom criteria, a user such, as a programmer, may base the parameters on low latency defined by a shorter length between the path from the first NoC element to the second NoC element. The user may define a maximum length threshold for a path. Configuration filtering module 1507 may remove a path if the length of the path exceeds the user defined threshold. In another example, the parameters may be based on the use of a minimum number of extra wires. In another example, a parameter may be based on a cost function that favors a lower-cost route from the first NoC element to the second NoC element.

A user may control the way in which new segments are created. Communication policy 1506 may have a set of parameters that may be associated with any given connection in the NoC topology. Communication policy 1506 may have parameters and flags. A first example of a flag may allow low latency where a connection should be implemented in a way that minimizes the total path length from source to destination. A second example of a flag may allow serialization for wire connections between source to destination to save wire.

Some possible configurations for a given connection may not be legal with respect to communication policy 1506. Eligible configurations 1508 may be characterized as a filtered version of legal configurations. For example, if a connection from the first NoC element to the second NoC element is set to have a low latency communication policy, then a limit on the total length of the route and the number of hops or traversed NoC elements are applied. Possible configurations that do not fall within these limits are discarded.

Configuration filtering module 1507 outputs eligible configurations 1508, and a configuration selection module 1509 may select one of the eligible configurations. The configuration selection module 1509 may retain only one final configuration to be implemented as the final synthesis of a connection from the first NoC element to the second NoC element. The metric used to select a best configuration is configurable and may take several parameters into account as specified by communication policy 1506.

The synthesis tool 220 may implement the selected configuration 1510. At block 512, the segments involved are split and new segments and turns in the NoC topology are created. When a segment is split, it is split at all the existing segments that need to be connected to new segments at the points dictated by the chosen configuration. In regards to optimization, if the splitting point is within a certain distance from one of the segment's endpoints, and the endpoint is a switch, then the endpoint may be reused for the connection instead of creating a new switch. This can reduce the number of created switches.

Newly created segments and turns in combination with existing segments and turns are input into routing tool 1513, which generates a final route 1514. The route is computed from the first NoC element to the second NoC element given the newly created segments. The final route 1514 may be stored in memory.

FIG. 16A illustrates a NoC topology 1600 having an element_S 1601 and an element_D 1602. If there is an existing network and a change is requested such as, a request for adding a new connection between element_S 1601 and element_D 1602, an incremental synthesis may be performed. In addition to blockages, certain IP blocks may create restrictions that a connection needs to navigate around.

FIG. 16B illustrates the NoC topology 1600 having an incremental synthesis result of a routing a connection from element_S 1601 to element_D 1602. There is a new entry segment 1603 from element_S 1601 and a nearby NoC element 1606 with new internal segment 1604 and an exit segment with a NoC element 1605 neighboring element_D 1602. The exploration of legal configurations 1505 is shown in FIG. 16B, where entry segment 1603 is added if NoC element 1605 is not already connected to an existing segment in the NoC topology.

In the illustration of FIG. 16B, the exit segment is already existing because element_D 1602 is already connected to another NoC element. And since element_D 1602 is already connected to an existing NoC element, it already has an exit segment. A new exit segment may be a configuration option for connecting some segment of the existing NoC topology to element_D 1602.

In some embodiments, a synthesis tool herein may employ a machine learning model to suggest and generate new segments. The machine learning model may be trained on data sets based on feedback from previous design generation.

A new connection is added to the NoC topology only if it does not create a cyclic dependency, thereby ensuring only deadlock-free configurations are considered.

In some embodiments, the synthesis tool may compute connections without creating any new switches and/or new segments. This may be the case if element_S 1601 and element_D 1602 are already connected in the NoC topology and the entry segment can already reach the exit segment given only the existing turns. In some embodiments, a machine learning model may be trained to identify connections that can be made without creating any new switches or segments.

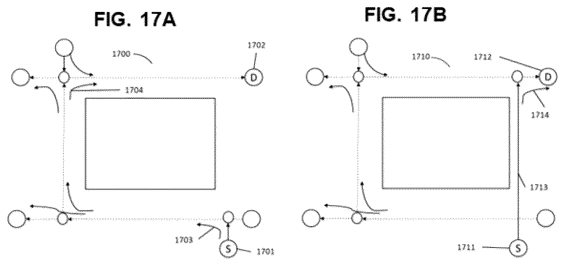

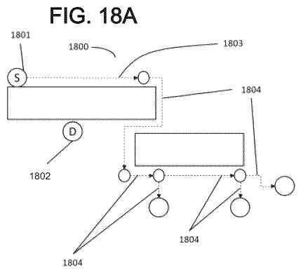

FIG. 17A illustrates a subnetwork 1700 that optimizes wire length as directed by a communication policy. FIGS. 17A and 17B show how the same connection may lead to different implementations based on the communication policy. In FIG. 17A, the element_S 1701 is connected to element_D 1702 where wire length is the main criterion of optimization. The configuration selection module, which may be controlled by a machine learning model, selects an implementation that creates minimum extra wire. It is shown that having short entry segment 1703 and one turn 1704 meets parameter requirements.

FIG. 17B illustrates a subnetwork 1710 emphasizing low latency communication as directed by a communication policy. In this example, there is a preference for a direct connection 1713 between element_S 1711 and element_D 1712 (rather than traversing several NoC elements). Turn 1714 is new, and it is near element_D 1712. Although extra wires are created and cost is added, the direct connection 1713 offers the shortest length.

In some embodiments of incremental synthesis, only the newly created NoC elements are configured. The existing NoC elements are left unaltered. That is, the existing NoC elements are immutable.

Existing segments and turns may be altered. In some embodiments, the existing turns and segments may be altered by a machine learning model that is trained for NoC generation. In other embodiments, the communication policy 1506 may direct the creation and selection of not only the new segments, but the modification of the existing segments. In an example, reusing an existing segment in new connections may not be desirable due to performance considerations or to previous optimizations that a user may have implemented and that depend upon the segment remaining unaltered. When a segment is split, a hop may be added to traverse a plurality of routes, which may not be a desired outcome. As a result, the synthesis tool 220 may define a number of incrementality levels, or modes, that are based on physical mutability of segments, physical mutability of switches, and logical mutability of network elements. It is more desirable to capture a user's intent when synthesizing a set of new connections in the presence of an existing NoC topology.

In some embodiments of incremental synthesis, a user may customize how the existing topology is altered.

In regards to physical mutability of segments, a segment is mutable by default. The segment may be split to fork-out a new segment. A user may make a segment immutable if, for example, it is not desired to have a switch added to an existing route.

Referring to physical mutability of switches, a new segment may be connected to an existing endpoint of an immutable segment if the endpoint is a switch. If it is not desired to modify the physical size of the switch, then the switch may be immutable so that no new segments can be connected to the immutable switch.

Referring now to logical mutability of network elements, as a default, existing NoC elements including, but not limited to, data width and/or an assigned clock, are not reconfigured by the incremental synthesis process. Only newly created switches and adapters are configured. This may lead to inefficient configurations such as insufficient bandwidth and/or too many clock domain crossings. Any NoC element may be marked as logically mutable to allow existing components to be reconfigured given new resulting topology.

Preset incremental synthesis modes can be defined based on the aforementioned concepts. Several preset modes will now be discussed.

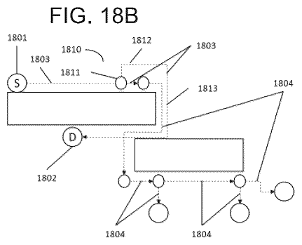

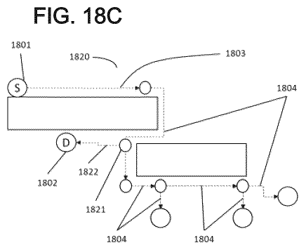

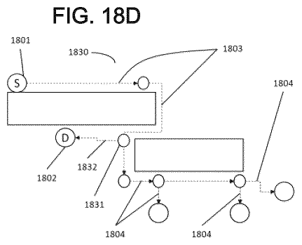

FIG. 18A illustrates an incremental synthesis mode for subnetwork 1800 for initial setup of segments being connected from element_S 1801 to element_D 1802. High bandwidth segments 1803 and low bandwidth segments 1804 traverse the existing subnetwork 1800. During initial setup, user parameters determine how the existing subnetwork 1800 is altered to connect element_S 1801 to element_D 1802.

FIG. 18B illustrates an incremental synthesis mode 1810 for physical immutability of segments (parameter may indicate minimal change). A segment is split at NoC element 1811 to fork-out a new segment 1812, and a U-turn is created in a deadlock-free manner to connect element_S 1801 to element_D 1802 with minimal change. High bandwidth segments 1803 are unaltered to prevent splitting, and low bandwidth segments 1804 are routed around existing NoC elements.

If it is more desirable to preserve the greatest amount of existing topology, all segments are made physically immutable with the exception entry and exit segments because entry and exit segments are used for implementing new connections. All existing NoC elements are physically immutable and all the NoC elements are logically immutable. For example, if a segment from element_S 1801 to element_D 1802 is marked immutable, the marked segment will not be split, and a route around an existing segment will be added. As a result, the existing segment remains unchanged.

FIG. 18C illustrates an incremental synthesis mode for logical immutability of segments (where a parameter specifies topology optimization and configuration preservation) in subnetwork 1820. Low bandwidth segment 1804 is split by NoC element 1821, and forked-out new segment 1822 and a new turn are created to connect element_S 1801 to element_D 1802. High bandwidth is not fully utilized because it is connected to a lower bandwidth and the switches cannot be changed. It would be more desirable for some switches to be changed to adapt. This preset mode allows for existing segments to be split and for switches to have new connections for more optimized topologies. As a result, a better cost (in terms of resources and wire usage) through the reuse of existing elements may be achieved. Existing NoC elements may be made logically immutable to maintain, for example, clock frequency, a clock assigned to a switch, and/or other attributes.

FIG. 18D illustrates an incremental synthesis mode for mutability of NoC elements (where a parameter specifies topology optimization and configuration adaptation) in subnetwork 1830. High bandwidth segment 1803 is split by NoC element 1831, and forked-out new segment 1832 are created to connect element_S 1801 to element_D 1802. High bandwidth may be fully utilized by reconfiguring the NoC elements to higher bandwidth. This incremental synthesis mode is advantageous where clock frequency is increased to improve performance.

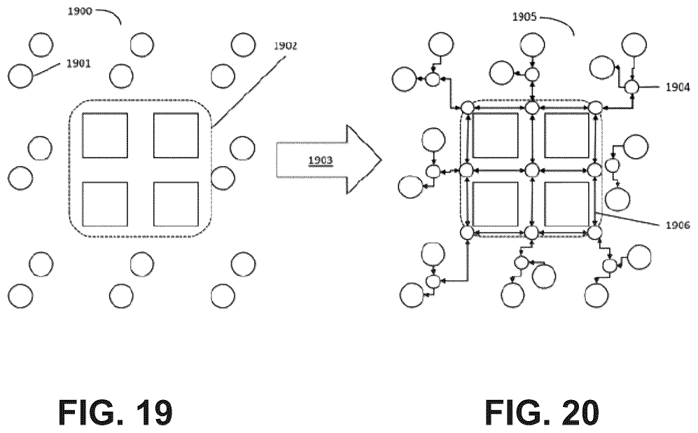

FIGS. 19 and 20 illustrate incremental synthesis applied to a mesh custom subnetwork description. A custom subnetwork description describes a subnetwork to be generated before the synthesis starts. The custom subnetwork description may include the following:
a geographical boundary, such as a rectangular area used to place a subnetwork within the NoC topology;
a subnetwork type, which can be one of several pre-defined regular network types (e.g., a mesh, a torus); and
a configuration.

The configuration may be specific to the type of subnetwork. For example, the configuration of a mesh may specify the number of rows, columns, and the routing algorithm (e.g. XY, North-Last).

FIG. 19 shows a subnetwork 1900 that starts with a plurality of NoC elements 1901. There are no connections between the NoC elements 1901 of FIG. 19. FIG. 19 also identifies a requested space 1902 for a mesh. It is sometimes preferrable to opt for a known regular topology, such as a mesh, due to its simplicity and efficiency in terms of implementation cost and bandwidth distribution.

Incremental synthesis 1903 is performed to produce the subnetwork 1905 of FIG. 20. New mesh segments are generated and physically placed optimally within a specified region 1906.

The mesh may occupy the largest possible area within its specified region 1906. Typical mesh segments are straight and do not physically collide with any obstacles. Segment size may be made as even as possible.

In some embodiments, the mesh segments may be generated algorithmically. In other embodiments, the mesh segments may be generated by a machine learning model trained on topology synthesis and generation. An XY routing algorithm may be used to identify and select a region for the mesh.

The new mesh segments, now considered as pre-existing segments, are used opportunistically when appropriate to generate a subnetwork 1905 that is fully connected. The subnetwork 1905 is fully connected in that each NoC element 1901 connects to every other NoC element 1901 via the mesh and new switches 1904. As a result of the synthesis 1903, subnetwork 1905 uses a mix of the automatically generated mesh and newly optimally synthesized segments.

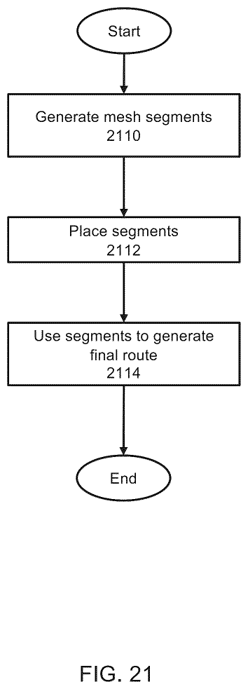

FIG. 21 illustrates a method of using a mesh custom subnetwork description to add a mesh to a NoC topology. At step 2110, mesh segments are generated and physically placed optimally on a requested space. At step 2112, the new mesh segments, now considered as pre-existing segments by the incremental synthesis process, are used opportunistically, whenever appropriate. At step 2114, using the pre-existing segments, routes are generated. The updated NoC topology includes a mix of an automatically generated regular mesh topology and new optimally synthesized segments.

The synthesis tool 220 may perform segment replacement during incremental topology synthesis by targeting very specific parts of an existing NoC topology. The targeting results in incremental topology synthesis that is highly flexible.

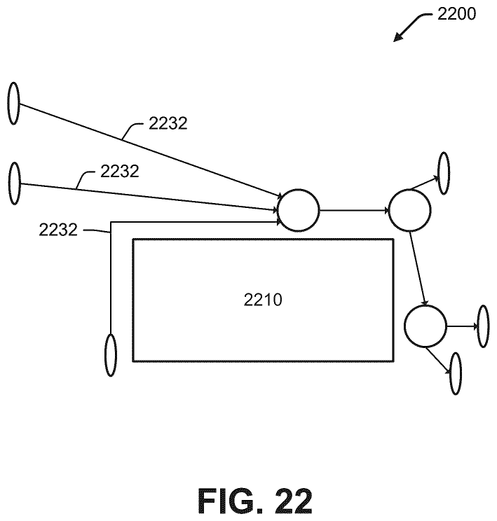

Referring now to FIG. 22, a subnetwork 2200 is shown with blockage area 2210 and NoC elements placed outside of the blockage area 2210. The synthesis tool 220 treats the NoC elements of FIG. 22 as pre-existing, and it will optimize only specific parts based on new inputs (e.g., physical information). For example, the synthesis tool 220 preserves the existing NoC elements and their placement, and it will optimize wire length by improving wire sharing between the segments going in the same direction.

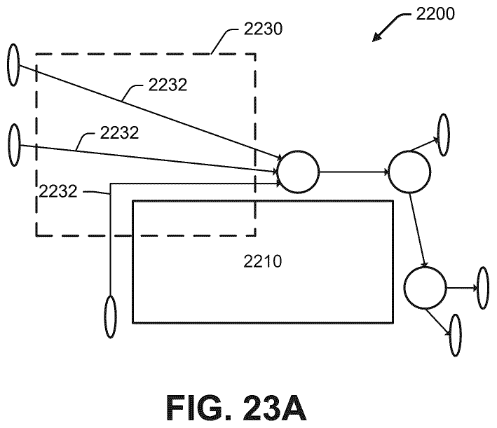

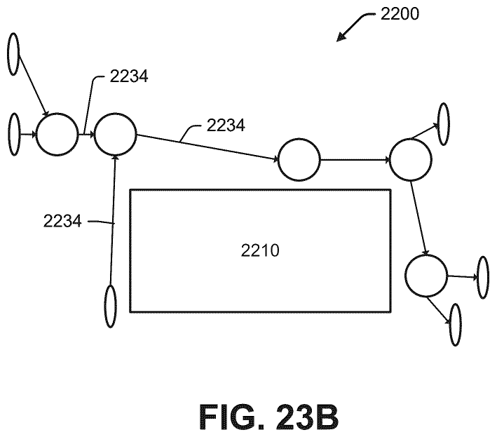

FIG. 23A and FIG. 23B illustrate wire optimization performed by the synthesis tool 220. In FIG. 23A, region 2230 identifies wire segments 2232 for replacement. The segments 2232 go in the same direction. The region 2230 may be identified algorithmically, manually by a user, or by a trained machine learning model.

FIG. 23B shows the segments 2232 replaced with a combination of switches and new segments 2234 to implement wire sharing between segments going in the same direction. Wire length of the segments 2234 in FIG. 23B is less than wire length of the segments in FIG. 23A.

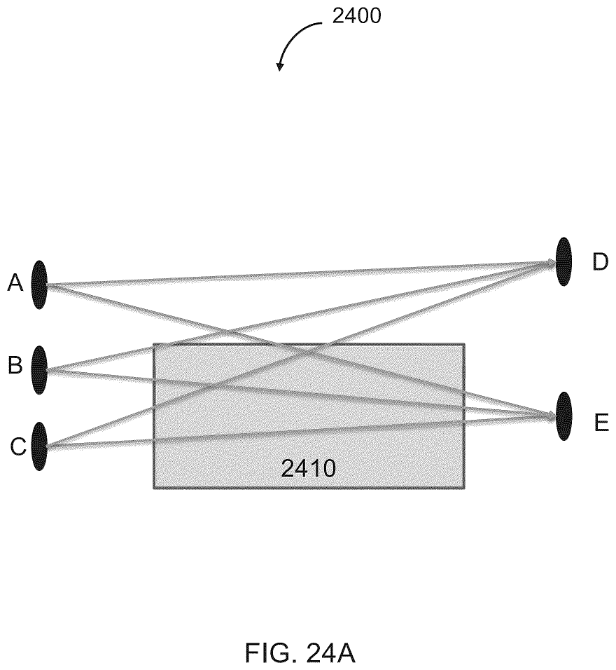

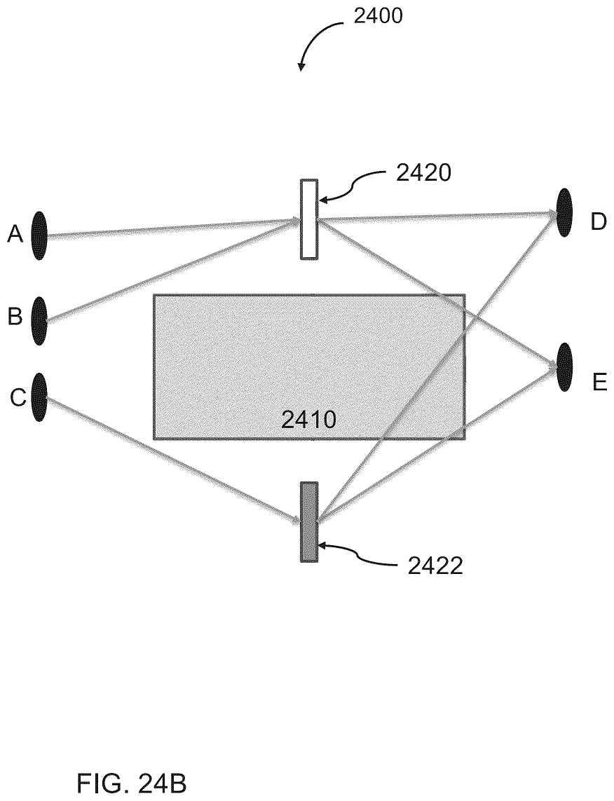

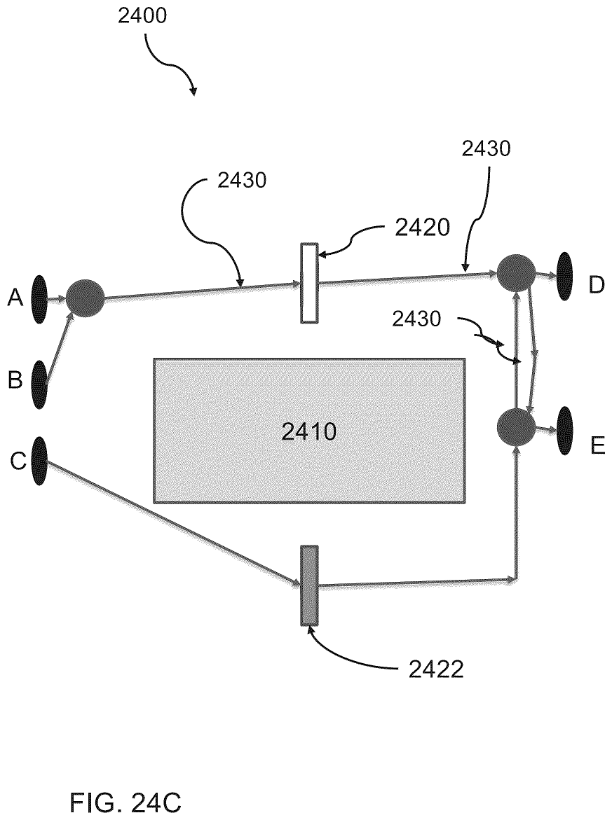

Incremental topology synthesis may involve the insertion of NoC elements other than switches. FIGS. 24A, 24B, and 24C illustrate some examples.

FIG. 24A shows a subnetwork 2400 including initiator NIUs A, B, and C, and target NIUs D, and E. There is a blockage area 2410. Segments from the initiator NIUs A, B and C to the target NIUs D and E are shown, but some of the segments are invalid as they cannot pass through the blockage area 2410.

FIG. 24B shows the subnetwork 2400 after a designer decides to insert a mandatory passage element 2420. The mandatory passage element 2420 may include, for example, a firewall, a probe, an adapter, or an empty element that is used to guide segments through specific points in the subnetwork 2400.

Consider an example in which the mandatory passage element 2420 is a firewall. It is desirable for connections starting from initiator NIUs A and B to go through the firewall, and a connection going from initiator NIU C to be probed by a debug port 2422. Some of the segments are invalid because switches are missing and those segments cannot pass through the blockage area 2410.

FIG. 24C shows the subnetwork 2400 after the synthesis tool 220 applies a topology synthesis algorithm and/or a trained machine learning model to add switches and valid segments 2430. The switches and valid segments 2430 replace the invalid segments.

In some embodiments, the synthesis tool 220 provides a user interface that enables a designer or other user to explicitly specify segments and switches to replace. When a switch is selected for replacement, it may be transformed into a set of segments representing the internal connections of the switch. The segments are then marked for replacement. The user interface may also enable a user to identify switches that are missing.

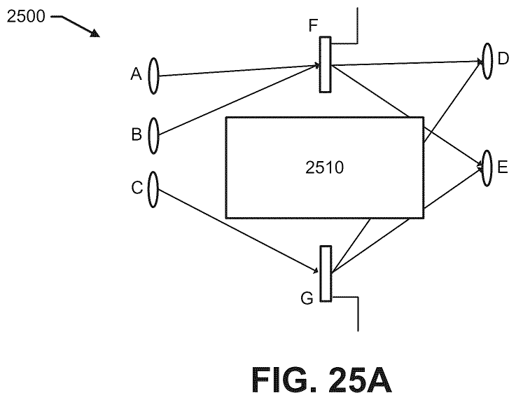

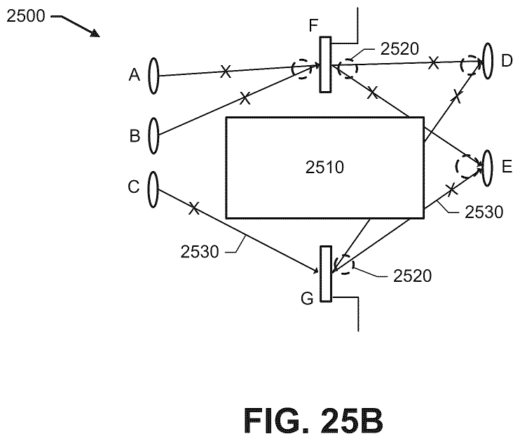

FIG. 25A shows a subnetwork 2500 including initiator NIUs A, B and C, target NIUs E and F, a firewall G and a probe H. There is also a blockage area 2510. Switches are missing, and segments passing through the blockage area 2510 are invalid.

FIG. 25B shows the subnetwork 2500 after missing switches have been identified. Locations of the missing switches are represented by circles in dash and referenced by numeral 2520.

FIG. 25B also shows certain segments 2530 that have been marked for replacement. For the purpose of illustration, segments 2530 marked for replacement are marked with an “X.”

In some embodiments, the synthesis tool 220 may be configured with a user interface, which enables a user to manually identify missing switches and mark segments for optimization or replacement. In some embodiments, the synthesis tool 220 is configured to algorithmically detect missing switches and mark segments for optimization or replacement. In some embodiments, the synthesis tool 220 is configured to use a machine learning model to detect missing switches and mark segments for optimization or replacement. In some embodiments, the synthesis tool 220 may be further configured to replace the marked segments and add the missing switches.

The incremental synthesis may be used to generate training data for the machine learning model. In some embodiments, the synthesis tool 220 is configured to tag each segment to replace with a communication policy, to route it in a specific way. The tagging may be used as training data for the machine learning model.

FIGS. 26A, 26B, and 26C show a subnetwork 2600 that includes initiator NIUs A and B are target NIUs C, D and E. The subnetwork 2600 also includes firewall F and G. There is a blockage area 2605. There is also an external socket connectivity or dependency 2610 (shown in dash) from target NIU E to initiator NIU A. All of the segments are marked for replacement and optimization, including segment 2620.

FIG. 26B shows the subnetwork 2600 after optimization. The synthesis tool 220 replaces dedicated segments, including segment 2620, with shorter dedicated segments, shared segments, and switches.

If the marked segments are replaced independently of each other, a potential deadlock may occur. For example, if firewalls F and G are considered independently and wire usage is only considered during optimization, the optimization creates a cycle from initiator NIU A to target NIU C to target NIU D to target NIU E and back to initiator NIU A (due to the dependency 2610).

The synthesis tool 220 identifies the cycle. The synthesis tool 220 keeps the segments that were marked for replacement inside the subnetwork 2600, including segment 2620. The synthesis tool 220 may also assign a special state or status to the segments marked for removal. The synthesis tool 220 does not use these special state or status segments for actual routing.

As shown in FIG. 26C, the synthesis tool 220 then proceeds to break the cycle by not modifying segment 2620 for wire sharing. Thus, segment 2620 is restored and modified to avoid the blockage area 2605. Wire cost is increased, but two switches are eliminated, and a potential deadlock is avoided.

However, there is still a cycle from initiator NIU A to firewall G to target NIU E and back to initiator NIU A (again, due to the dependency 2610). The synthesis tool 220 determines that shared wire 2630 should not be used, and the dedicated segments at initiator NIUs A and B should be restored.

FIG. 26D shows a deadlock-free subnetwork 2600. The deadlock-free subnetwork 2600 of FIG. 26B does not have a route from initiator NIU A to target NIU E.

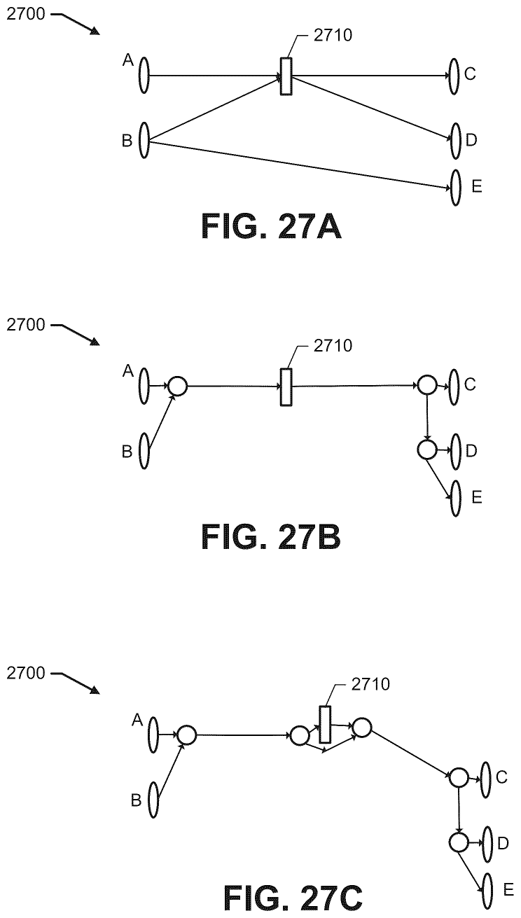

Reference is now made to FIGS. 27A, 27B and 27C. FIG. 27A shows a subnetwork 2700 including initiator NIUs A and B, target NIUs C, D and E, and a passage point 2710. The synthesis tool 220 performs optimization on the subnetwork 2700 to minimize wire cost, and produces the subnetwork 2700 of FIG. 27B.

In FIG. 27B, the passage point 2710 is not exclusive. Thus, other routes can pass through passage point 2710, such as the route from initiator NIU B to target NIU E.

In some embodiments, the synthesis tool 220 is configured to enable a designer or other user to identify exclusive passage points to ensure that certain connections are not routed through those exclusive passage points.

In FIG. 27C, the passage point 2710 is modified to prevent passage of the route from initiator NIU B to target NIU E. In response, the synthesis tool 220 automatically adds new switches and new segments so that the route from initiator NIU B to target NIU E is routed around the passage point 2720.

Each NoC element may be tested to ensure a location within the bounds of the specified clock and power domain. If a test fails, the NoC element is moved to a new location until the test is passed. Once a suitable location has been found for each NoC element, routes between NoC elements are determined. After routing is performed, distance-spanning pipeline elements may be are inserted. For instance, the decision to insert a pipeline elements may be based on information provided regarding the capabilities of the technology, and how long it takes for a signal to cover a 1 mm distance.

Various adapters and buffers may also be inserted. The insertion of adapters may be based on the adaptation for two NoC elements that have different data width, different clock and power domains. The insertion of buffers may be based on the scenarios and detected rate mismatch.

After a NoC topology has been finalized, the synthesis tool 220 may generate one or more computer files describing the final NoC topology. The file or files may include a list of NoC elements with their configuration (e.g., data width, clock domain); the position of each generated NoC element in the final topology; and the set of routes going through the NoC elements.

Each route may be specified as an ordered list of network elements, one for each initiator-target pair, and one for each target-initiator pair. A route represents how traffic between the pairs will flow and through which NoC elements.

In some embodiments, the synthesis tool 220 may be configured to generate metrics about the final NoC topology. Examples of metrics include a histogram of wire length distribution, number of switches, and a histogram of switch by size.

The one or more computer files may be in a machine-readable form using a well-defined format to capture information. An example of such a format is XML, another example of such a format is JSON.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code including instructions according to various example.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Various examples are methods that use the behavior of either or a combination of machines. Method examples are complete wherever in the world most constituent steps occur. For example, and in accordance with the various aspects and embodiments of the invention, IP elements or units include: processors (e.g., CPUs or GPUs), random-access memory (RAM—e.g., off-chip dynamic RAM or DRAM), a network interface for wired or wireless connections such as ethernet, WIFI, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media including any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

What is claimed is:

1. A computer-implemented method for designing a network-on-chip (NoC), the method comprising:
accessing an existing NoC topology having existing NoC elements including network interface units and switches, the existing NoC topology further having blockages and existing wire connections;
creating an updated NoC topology from the existing NoC topology, including adding at least one new wire connection to the existing wire connections;
identifying turns and segments in the existing and new wire connections in the updated NoC topology; and
ensuring that no cycles are created by the segments that form turns, whereby the updated NoC topology is deadlock-free.

2. The method of claim 1, wherein ensuring that no cycles exist includes:
identifying any cycles among the segments and the turns; and
if a cycle is identified, breaking the cycle by performing segment splitting to create sub-segments with variable routes.

3. The method of claim 2, wherein if a given segment is split at a point that is within a threshold distance from a switch at an endpoint of the given segment, the endpoint is connected to the switch.

4. The method of claim 1, wherein ensuring that no cycles exist includes:
identifying any cycles among the segments and the turns; and
if a cycle is identified, eliminating at least one new wire connection to break the identified cycle.

5. The method of claim 1, wherein a plurality of wire connections are added to the updated NoC topology; wherein the plurality of wire connections are added incrementally; and wherein ensuring that no cycles exist is performed incrementally.

6. The method of claim 1, wherein creating the updated NoC topology further includes adding new NoC elements; and wherein the at least one new wire connection connects the added new NoC elements to the existing NoC topology.

7. The method of claim 6, wherein the existing NoC elements are treated as physically immutable but logically mutable, and the new NoC elements are treated as physically mutable and logically mutable.

8. The method of claim 1, wherein creating the updated NoC topology further includes replacing a plurality of wire connections going in a same direction with a shared wire connection; and wherein ensuring that no cycles exist includes ensuring that the shared wire connection does not cause a cycle in the updated NoC topology.

9. The method of claim 1; wherein creating the updated NoC topology further includes marking certain wire connections; and wherein marked wire connections are not used in a final NoC topology but are used to ensure that no cycles exist due to an external dependency.

10. The method of claim 1, further comprising marking invalid segments for replacement in the updated NoC topology; wherein ensuring that no cycles exist includes using segments marked as invalid to determine whether any cycles exist in the updated NoC topology due to an external dependency.

11. The method of claim 1, wherein the existing NoC elements include a regular subnetwork; wherein a plurality of new NoC elements are added to the NoC topology; and wherein the at least one new wire connections are made to fully connect the plurality of new NoC elements via the regular subnetwork.

12. The method of claim 1, further comprising generating a description of the updated NoC topology, including a list of the NoC elements in the updated NoC topology, logical attributes of the NoC elements in the list, and set of routes through the NoC elements in the list.

13. An electronic computer aided design (ECAD) tool comprising computer-readable memory encoded with code for designing a network-on-chip (NoC) topology, wherein the code, when executed by a computer system, causes the computer system to:
access an existing NoC topology having existing NoC elements including network interface units and switches, the existing NoC topology further having blockages and existing wire connections;
create an updated NoC topology from the existing NoC topology, including treating the existing NoC elements as physically immutable, and adding at least one new wire connection to the existing wire connections;
identify turns and segments in the existing and new wire connections in the updated NoC topology; and
ensure that no cycles are created by the segments that form turns, whereby the updated NoC topology is deadlock-free.

14. An electronic computer aided design (ECAD) tool to generate a deadlock free network-on-chip (NoC), the tool comprising a non-transitory computer readable medium for storing code, which when executed by one or more processors, causes the tool to:
identify a region within a NoC topology for incremental optimization;
identify routes in a same direction that can be reused;
identify routes to be eliminated and mark the routes to be eliminated; and
determine whether any route that is marked would result in a deadlock due to an external dependency.

15. The tool of claim 14, wherein the code, when executed, further causes the tool to generate a regular subnetwork from a custom subnetwork description; and place the regular subnetwork in the identified region.

16. The tool of claim 15, wherein the code, when executed, further causes the tool to add a plurality of new NoC elements to the NoC topology; and fully connect the plurality of new NoC elements via the regular subnetwork.

17. The tool of claim 15, wherein the regular subnetwork includes a mesh; and wherein a machine learning model is used to generate the mesh.

18. The tool of claim 14, wherein the code, when executed, further causes the tool to replace a plurality of marked routes going in the same direction with a shared route; and ensure that the shared route does not cause a cycle in the NoC topology.

19. The tool of claim 14, wherein a deadlock is determined by identifying any cycles from segments that form turns in the NoC topology.

20. The tool of claim 14, wherein the code, when executed, further causes the tool to generate a description of the NoC topology, including a list of NoC elements in the NoC topology, logical attributes of the NoC elements in the list, and routes through the NoC elements.
